(19) United States
(12) Patent Application Publication
(10) Pub. No.: US 2024/0277578 A1
(43) Pub. Date: Aug. 22, 2024

(54) SYSTEM AND PROCESS FOR MONITORING MEDICATION CONSUMPTION FOR PILL POUCH CONTAINERS

(71) Applicant: Medsense Health, Inc., Tacoma, WA (US)

(72) Inventors: Clark Emerick, Kirland, WA (US); Matthew Tabakin, Tacoma, WA (US)

(21) Appl. No.: 18/443,021

(22) Filed: Feb. 15, 2024

Related U.S. Application Data
(60) Provisional application No. 63/485,257, filed on Feb. 16, 2023.
(60) Provisional application No. 63/491,727, filed on Mar. 22, 2023.
(60) Provisional application No. 63/522,531, filed on Jun. 22, 2023.

(51) Int. Cl. A61J 7/04; A61J 1/03

(52) U.S. Cl. CPC A61J 7/0436; A61J 1/035; A61J 2200/70

(57) ABSTRACT

An adherence package including a housing and a sensor. The sensor supported is in the housing and is configured to detect movement of a strand of medication pouches stored in the housing.

### CROSS-REFERENCES TO RELATED APPLICATIONS

This application claims priority under 35 U.S.C. § 119 to U.S. Provisional Patent Application No. 63/485,257, filed Feb. 16, 2023, to U.S. Provisional Patent Application No. 63/491,727, filed Mar. 22, 2023, and to U.S. Provisional Patent Application No. 63/522,531, filed Jun. 22, 2023, the entire contents of which are incorporated herein by reference.

### BACKGROUND

In recent years, medication packaging has been developed to aid patients in correctly taking medication regimens. That is, packaging intended to help patients correctly stick to a medication schedule. Hence, these types of medication packaging are often referred to as adherence packaging. In an adherence package, medication doses are individually sealed along a roll of connected pouches, which is in turn packaged in a paper box for delivery to the patient. When a dose is due, the patient tears a pouch from the roll, opens the pouch, consumes the medication, and throws away the pouch. The subsequent pouch on the roll becomes the next dose. and.

While conventional adherence packages provide many benefits, they are also subject to various drawbacks. While conventional adherence packages usually include indicia informing the patient of when to consume the next dose, the patient or the patient's caregiver must remember and follow the medication schedule. Thus, a patient may forget to follow the medication regimen. Accordingly, more sophisticated and versatile medication packaging would be useful.

### SUMMARY

Some embodiments provide an adherence package including housing and a sensor. The sensor is supported in the housing and is configured to detect movement of a strand of medication pouches stored in the housing.

In some embodiments, the sensor is rotatably supported in the housing.

In some embodiments, the sensor is mounted in a carriage assembly.

In some embodiments, the carriage assembly is rotatably and slidably mounted in the housing.

In some embodiments, the housing includes a guide wall defining a guide groove, the carriage assembly rides in the groove, and the guide wall limits sliding movement of the carriage assembly.

In some embodiments, the sensor is mounted in a frame.

In some embodiments, the frame is slidably mounted in the housing.

In some embodiments, the housing defines a groove, a guide rail extends from the frame, and the guide rail is slidably received by the groove.

In some embodiments, the housing has a lip and a stop, and the frame engages the lip and the stop.

Some embodiments provide a medication dispensing system including a computing device and an adherence package. The adherence package is in communication with the computing device via a cloud network. The adherence package includes a housing and a sensor.

The sensor is supported in the housing and is configured to detect movement of a strand of medication pouches stored in the housing.

In some embodiments, the sensor sends motion data of the strand to the computing device.

In some embodiments, the computing device determines a motion event based on the motion data.

In some embodiments, the computing device determines whether a medication dose from the strand has been dispensed in accordance with a predetermined medication schedule based on the motion data.

In some embodiments, the computing device is in communication with a mobile device via the cloud network and the computing device sends medication reminders to the mobile device.

In some embodiments, the sensor is mounted in a carriage assembly and the carriage assembly is rotatably and slidably mounted in the housing.

In some embodiments, the carriage assembly includes a wheel and the carriage assembly rotates when the strand is pulled against the wheel.

In some embodiments, the housing includes a guide wall defining a guide groove, the carriage assembly rides in the groove, and the guide wall limits sliding movement of the carriage assembly.

Some embodiments provide a method for dispensing medication that includes determining, with a computing device, whether a strand of medication pouches has moved in an adherence package close to a dose time; if the strand of medication pouches has not moved in the adherence package close to the dose, determining, with the computing device, whether a maximum number of reminders has been sent to a mobile device in communication with the computing device; and if the maximum number of reminders has not yet been sent to the mobile device, sending, with the computing device, a reminder to the mobile device.

In some embodiments, the method also includes determining, with the computing device, whether the strand of medication pouches has moved in the adherence package during a waiting period after the reminder is sent.

In some embodiments, the computing device is a first computing device and the method also includes, if the maximum number of reminders has already been sent to the mobile device, contacting, with the first computing device, a second computing device of a health professional.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. illustrates a first adherence package operating in a medication dispensing system, according to the principles of this disclosure;

FIG. 2 is a side isometric view of the first adherence package of FIG. 1, according to the principles of this disclosure;

FIG. 3 is a rear isometric view of the first adherence package of FIG. 1, according to the principles of this disclosure;

FIG. 4 is a rear isometric view of a first door of the first adherence package of FIG. 1 separated from a first housing of the first adherence package of FIG. 1, according to the principles of this disclosure;

FIG. 5 is a partially exploded view of the first adherence package of FIG. 1 with an upper panel of the first adherence package of FIG. 1 removed, according to the principles of this disclosure;

FIG. 6 is a front isometric view of the first door of FIG. 4, according to the principles of this disclosure;

FIG. 7 is a rear upper isometric view of a first tracking assembly of the first adherence package of FIG. 1, according to the principles of this disclosure;

FIG. 8 is an isometric cross-sectional view of the first tracking assembly of FIG. 6, according to the principles of this disclosure;

FIG. 9 is a rear isometric view of a first dispensing sled of the tracking assembly of FIG. 6, according to the principles of this disclosure;

FIG. 10 is an upper isometric view of a first sensor assembly of the first tracking assembly of FIG. 6, according to the principles of this disclosure;

FIG. 11 is an exploded view of the first sensor assembly of FIG. 9, according to the principles of this disclosure;

FIG. 12 is a top view of the first tracking assembly of FIG. 6 in operation, according to the principles of this disclosure;

FIG. 13 is a flow diagram depicting a method for operating at least one device within the medication dispensing system of FIG. 1 according to the principles of this disclosure;

FIG. 14 is side isometric view of a second dispensing sled assembled into a second housing of a second adherence package, according to the principles of this disclosure;

FIG. 15 is a side isometric view of the second housing of FIG. 14, according to the principles of this disclosure;

FIG. 16 is a side isometric view of the second dispensing sled of FIG. 14, according to the principles of this disclosure;

FIG. 17 is a rear isometric view of a third adherence package, according to the principles of this disclosure;

FIG. 18 a side isometric view of a fourth adherence package, according to the principles of this disclosure;

FIG. 19 is a side isometric view of a fifth adherence package, according to the principles of this disclosure;

FIG. 20 is a partially exploded view of a sixth adherence package, according to the principles of this disclosure;

FIG. 21 is a rear isometric view of a seventh adherence package, according to the principles of this disclosure;

FIG. 22 is a front isometric view of an eighth adherence package, according to the principles of this disclosure;

FIG. 23 is a partial rear isometric view of the eighth adherence package of FIG. 22 in an open configuration, according to the principles of this disclosure;

FIG. 24 is a partial front isometric view of a lid portion of the eighth adherence package of FIG. 22, according to the principles of this disclosure;

FIG. 25 is a front isometric view of a dispensing clip, according to the principles of this disclosure;

FIG. 26 is a side isometric view of the dispensing clip of FIG. 25 attached to a box, according to the principles of this disclosure;

FIG. 27 is a side isometric view of a ninth adherence package, according to the principles of this disclosure;

FIG. 28 is a schematic view of a tracking assembly of the ninth adherence package, according to the principles of this disclosure;

FIG. 29 is schematic view of an adherence package station, according to the principles of this disclosure;

FIG. 30 is a schematic view of a first adherence package cart, according to the principles of this disclosure; and

FIG. 31 is a schematic view of a second adherence package cart, according to the principles of this disclosure.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

As explained above, it would be useful to provide more sophisticated and versatile medication packaging would be useful. More particularly, medication packaging that tracks and reports the dispensing of medication. FIG. 1 illustrates a medication dispensing system 100 according to one embodiment. The medication dispensing system 100 includes a first adherence package 102 and computing devices 104. The computing devices 104 include a computer terminal 106, a server 108, and a mobile device 110. The computing devices 104 are in communication with one another and the adherence package 102 via a cloud network 112. In some embodiments, the first adherence package 102 is additionally directly communicatively connected to the mobile device 110.

Referring to FIG. 1, in operation, a sensor 114 housed in the first adherence package 102 detects when a medication pouch 116 from an adherence medication strand 118 is dispensed from the first adherence package 102. The adherence medication strand 118 may be rolled and/or folded to fit in the adherence package 102. In some embodiments, the sensor 114 begins collecting motion data when the strand 118 is pulled beyond a threshold force vector. The sensor 114 sends motion data to one or more of the computing devices 104. Based on motion data from the sensor 114 and one or more motion profile algorithms 120 developed from previously captured motion data, one or more of the computing devices 104 determine whether the adherence medication strand 118 has undergone a motion event. Motion events include pulling out a single medication pouch 116, pulling out various numbers of multiple medication pouches 116, loading a fresh adherence medication strand 118, etc. In some embodiments, the motion profile algorithms 120 are stored on one or more of the computing devices 104. Additionally, in some embodiments, medication schedules 122 are stored on one or more of the computing devices 104.

Looking again at FIG. 1, further in operation, one or more of the computing devices 104 logs when medication pouches 116 are dispensed based on motion data from the sensor 114. In some embodiments, one or more of the computing devices 104 determine whether the medication pouch 116 was dispensed timely according to a predetermined schedule based on the presence or absence of motion data from the sensor 114. Additionally, in some embodiments, if the medication pouch 116 has not been dispensed on time, one or more of the computing devices 104 send and/or display reminders via the mobile device 110. Further, based on the motion data, the computing devices 104 send additional alerts and/or notifications to help patients take their medications. The computing devices 104 also send medication adherence reports to interested parties (e.g., doctors, nurses, health professionals, etc.) based on the motion data.

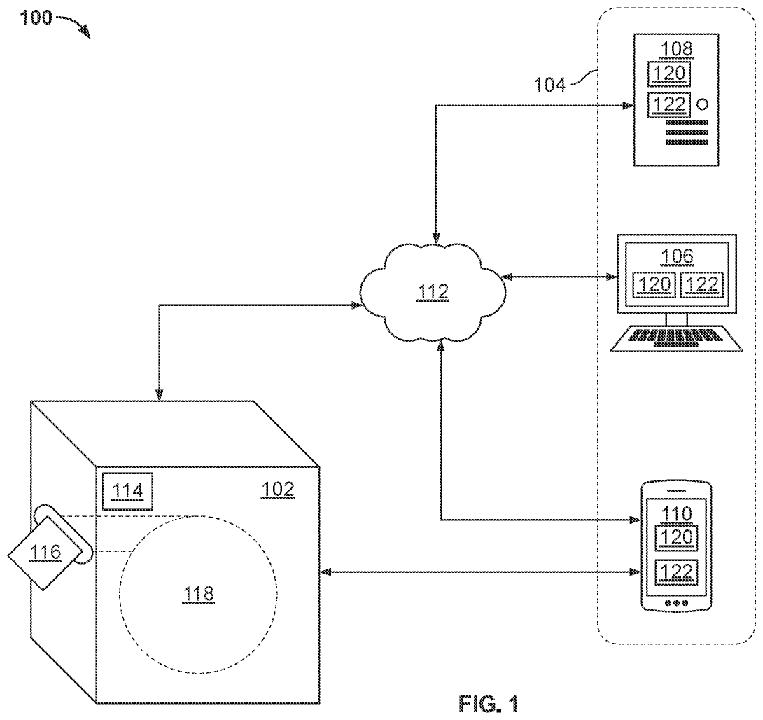

Referring to FIG. 2, the first adherence package 102 includes a tracking assembly 124 supported in a housing 126. The housing 126 includes a top panel 128, a bottom panel 130, a front panel 132, a back panel 134, a first side panel 136, and a second side panel 138. The tracking assembly 124 is supported by the first side panel 136 and the second side panel 138. The tracking assembly 124 is between and contacts the top panel 128 and the front panel 132. Further, the tracking assembly 124 has a tray 140 extending outwardly from the housing 126.

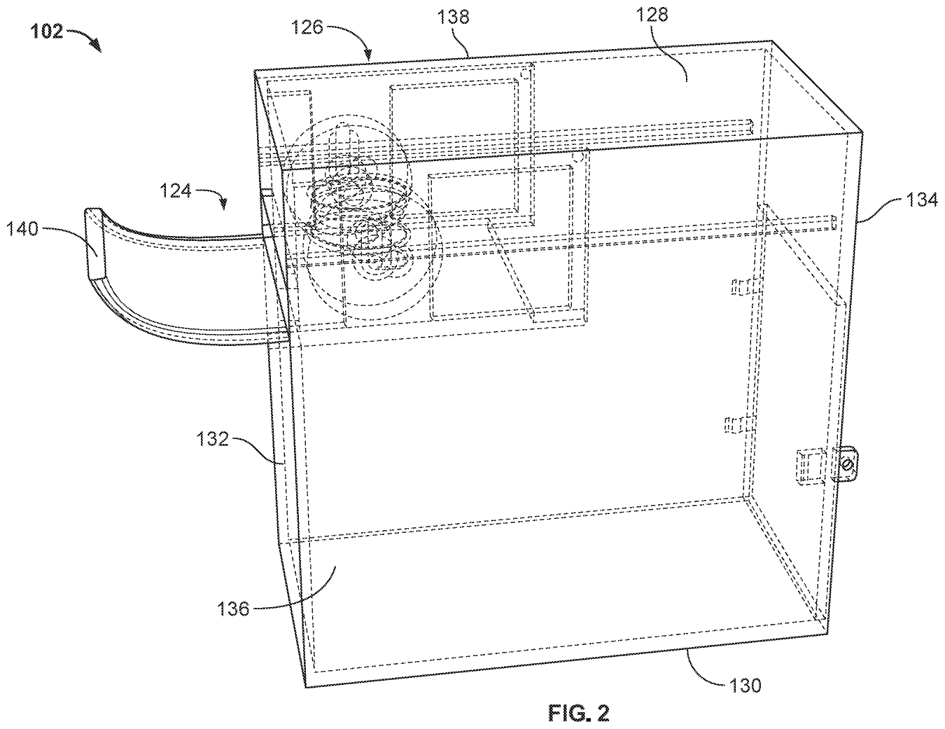

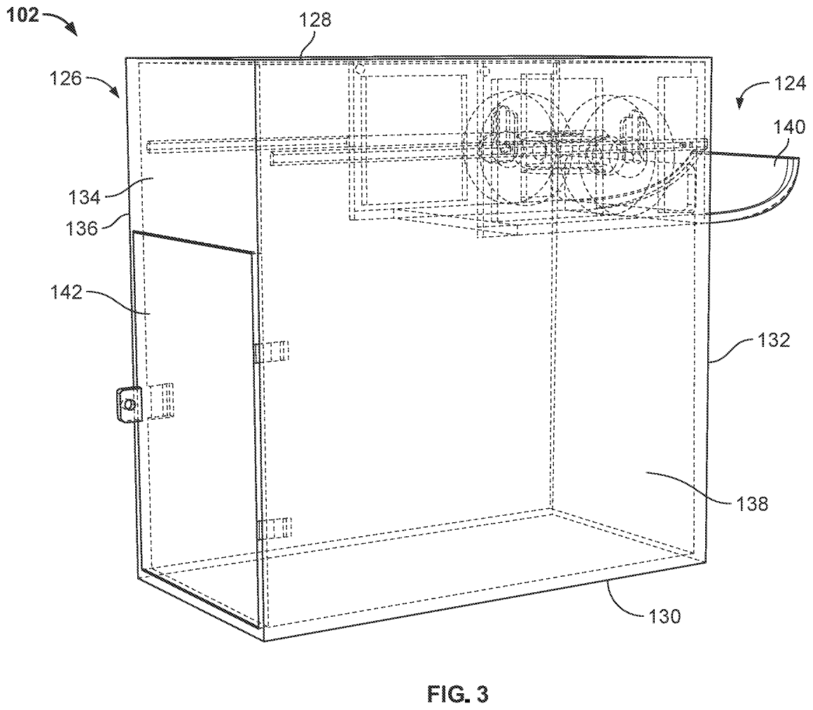

Turning to FIG. 3, the first adherence package 102 further includes a door 142 that snapably engages the first side panel 136 and the second side panel 138. The door 142 is between and contacts the back panel 134 and the bottom panel 130.

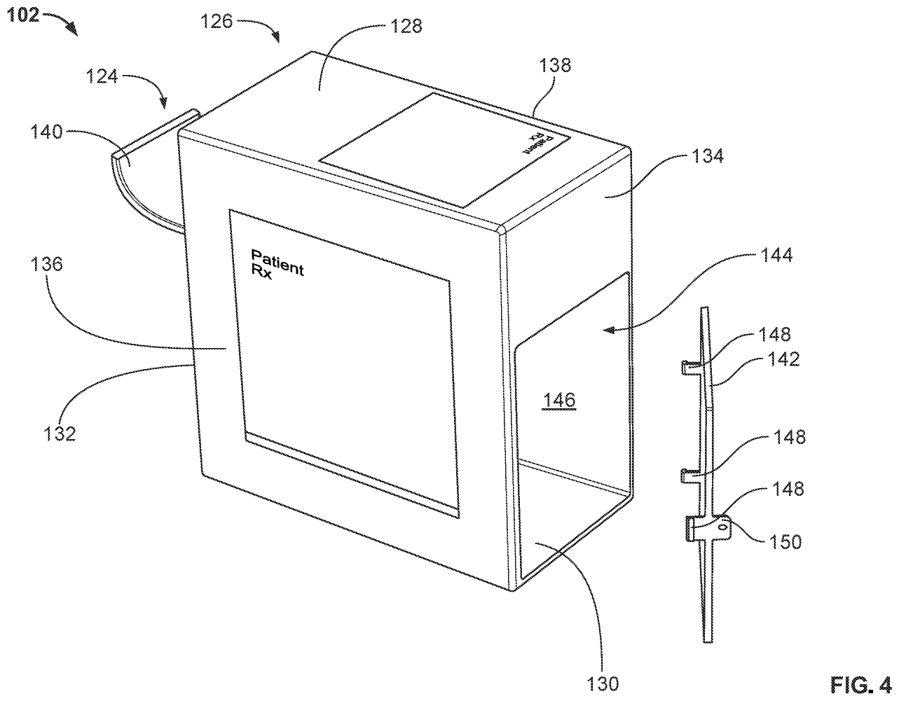

Looking to FIG. 4, the door 142 is removeable from the housing 126. The housing 126 defines an opening 144 that is in communication with a first cavity 146. The door 142 selectively covers the opening 144. The door 142 includes a plurality of snap tabs 148 to snapably engage the housing 126 and a pull tab 150 to pull the door 142 from the housing 126. In operation, a roll of medication pouches (not shown) is introduced to the first adherence package 102 via the opening 144 for storage in the first cavity 146.

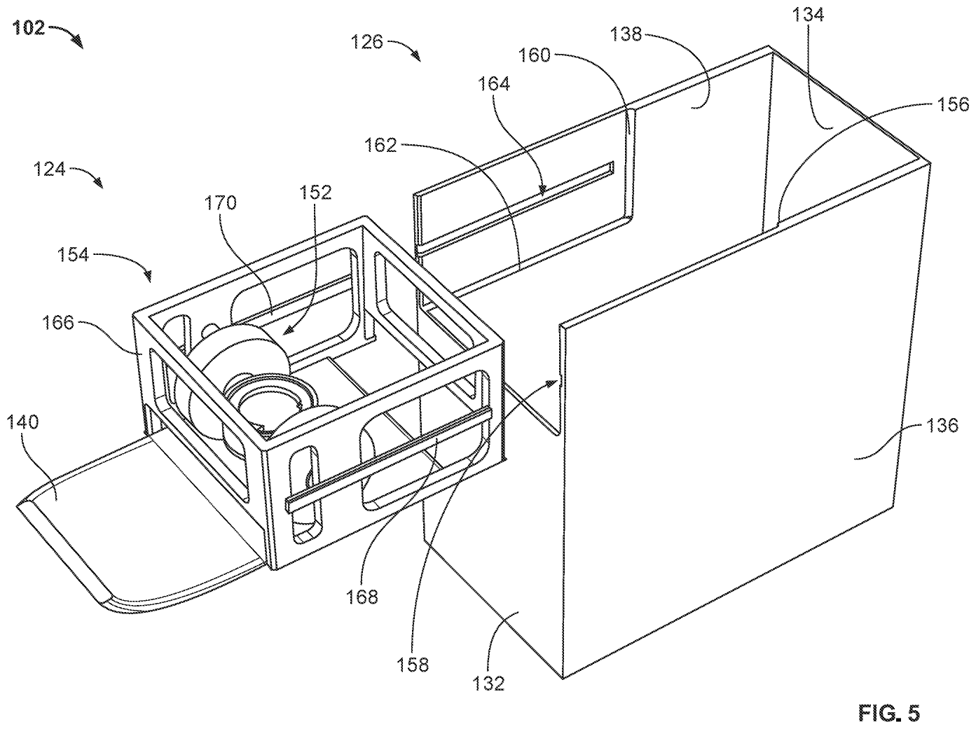

Referring to FIG. 5, the tracking assembly 124 includes a carriage assembly 152 supported by a dispensing sled 154. The first side panel 136 has a first stop 156 and a first lip (not shown) and defines a first groove 158. Similarly, the second side panel 138 has a second stop 160 and a second lip 162 and defines a second groove 164. The dispensing sled 154 includes a frame 166 that supports a first guide rail 168 and a second guide rail 170. The frame 166 slidably engages and is supported by the first lip and the second lip 162. The first guide rail 168 slidably engages and is supported by the first side panel 136 in the first groove 158. The second guide rail 170 slidably engages and is supported by the second side panel 138 in the second groove 164. The first groove 158 and the second groove 164 work to align the tracking assembly 124 relative to the first side panel 136 and the second side panel 138. The frame 166 contacts and seats against the first stop 156 and the second stop 160.

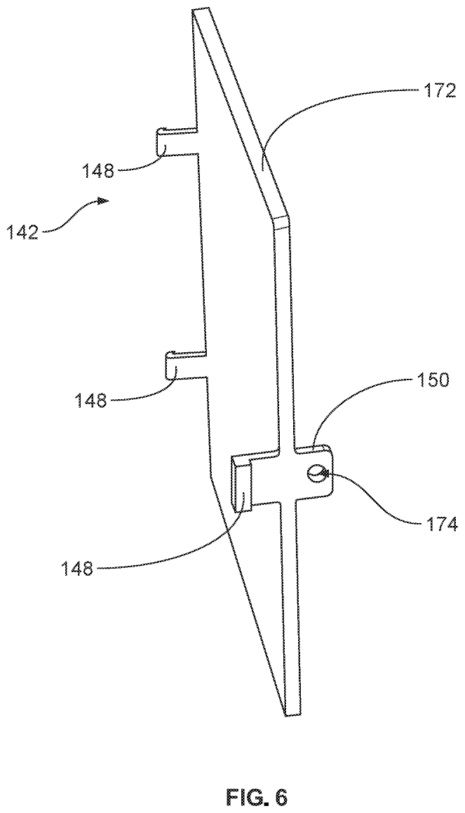

Turning briefly to FIG. 6, the door 142 also includes a closure panel 172. The snap tabs 148 and the pull tab 150 extend from the closure panel 172. Further, the pull tab 150 defines a hole 174 through which a tool may be inserted to aid in removing the door 142 from the housing 126 (shown in FIG. 4).

Referring to FIG. 7, the frame 166 supports the tray 140 and includes a front section 180 connected to and between a first side section 182 and a second side section 184. The tray 140 and the front section 180 define a dispensing opening 186. The first side section 182 supports the first guide rail 168. The second side section supports the second guide rail 170. The carriage assembly 152 is rotatably and slidably engaged with the frame 166 via the first side section 182 and the second side section 184. Additionally, the tray 140 extends beyond the front section 180 and curves upwardly.

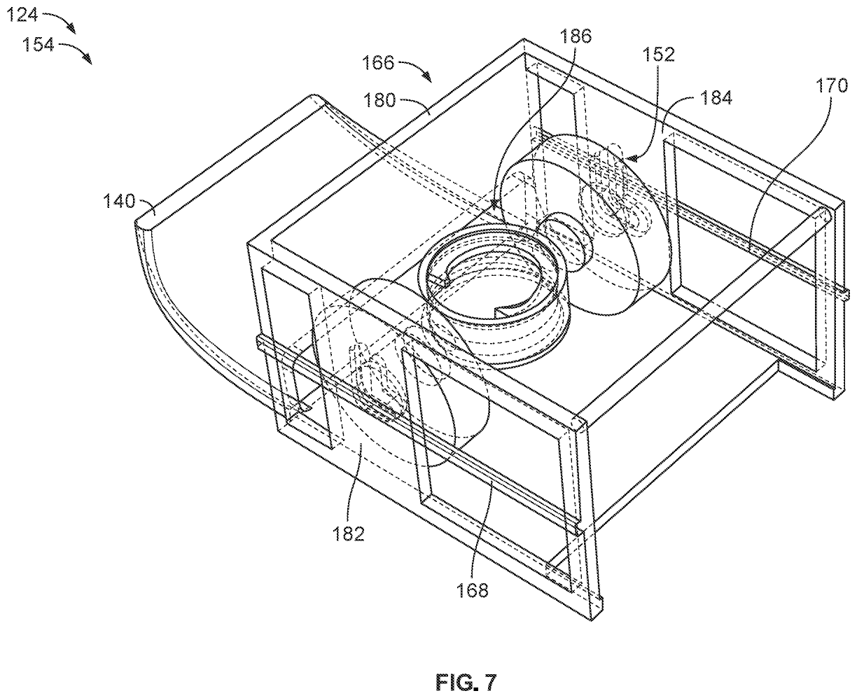

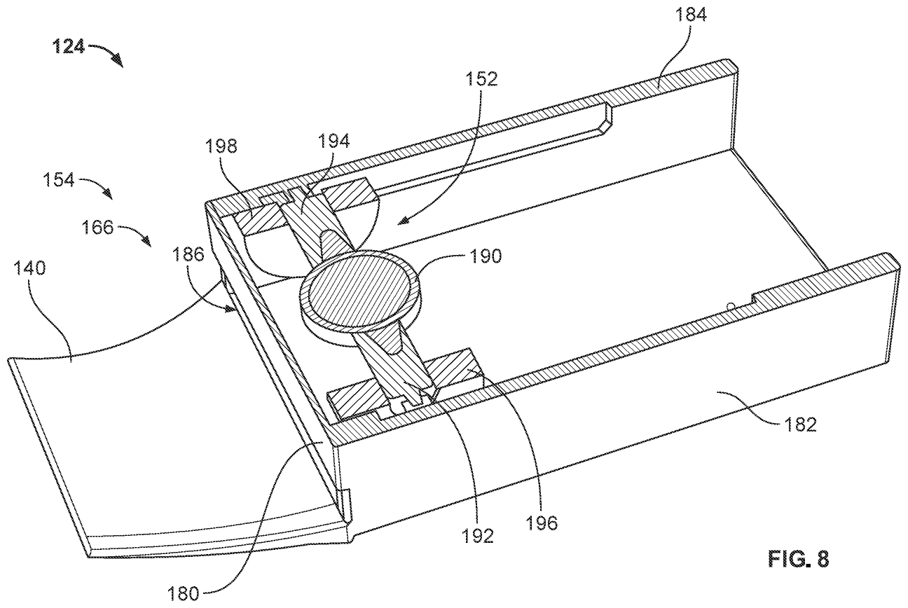

Looking to FIG. 8, the carriage assembly 152 includes a sensor assembly 190 supported by a first axle 192 and a second axle 194. The first axle 192 extends through a first wheel 196 to slidably and rotatably engage the first side section 182. Similarly, the second axle 194 extends through a second wheel 198 to slidably and rotatably engage the second side section 184.

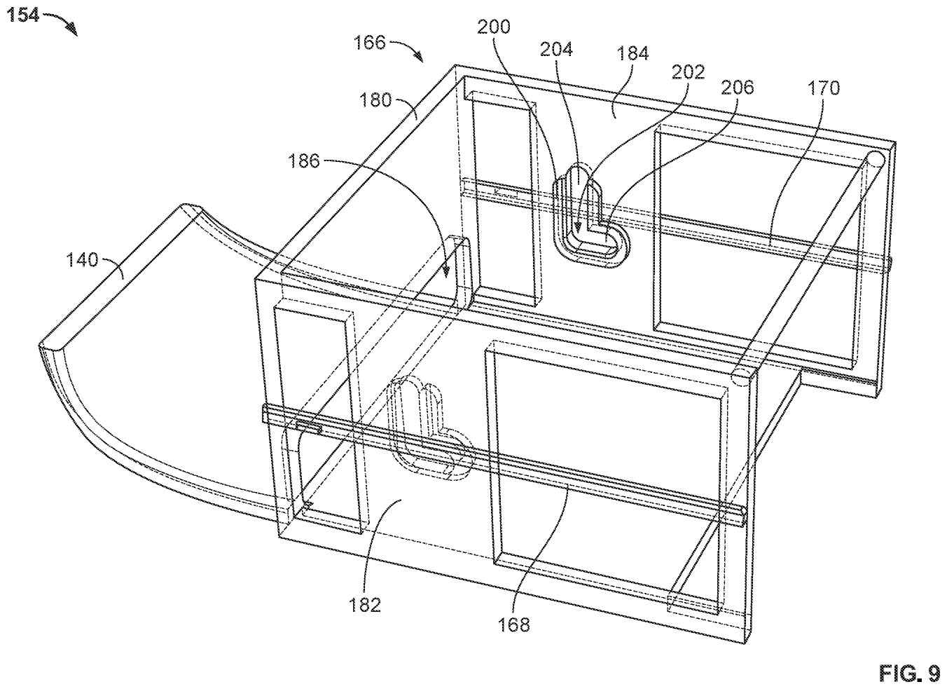

Turning to FIG. 9, the frame 166 further includes a first guide wall (not shown) defining a first guide groove (not shown) and a second guide wall 200 defining a second guide groove 202. The first guide wall extends from the first side section 182 inwardly toward the second side section 184. Similarly, the second guide wall 200 extends from the second side section 184 inwardly toward the first side section 182. The first guide wall and the second guide wall 200 are mirror images of another. Further, the first guide wall and the second guide wall 200 are meandering and/or serpentine. Thus, the first guide groove and the second guide groove 202 extend horizontally and vertically. More specifically, the first guide groove has an open first top end and a closed first aft end (not shown). Likewise, the second guide groove 202 has an open second top end 204 and a closed second aft end 206. In operation, the first axle 192 and the second axle 194 (shown in FIG. 8) are slidably and rotatably retained by the first guide wall and the second guide wall 200, respectively. Thus, the first axle 192 and the second axle 194 translatably and rotatably ride in the first guide groove and the second guide groove 202, respectively.

Referring to FIG. 10, the sensor assembly 190 includes the sensor 114 retained in a sensor holder 210 by a snap ring 212. The sensor holder 210 includes a conical first protrusion 214 and a conical second protrusion 216 extending from a cup portion 218. The first axle 192 and the second axle 194 (shown in FIG. 8) are correspondingly inwardly conically shaped to receive and engage the first protrusion 214 and the second protrusion 216.

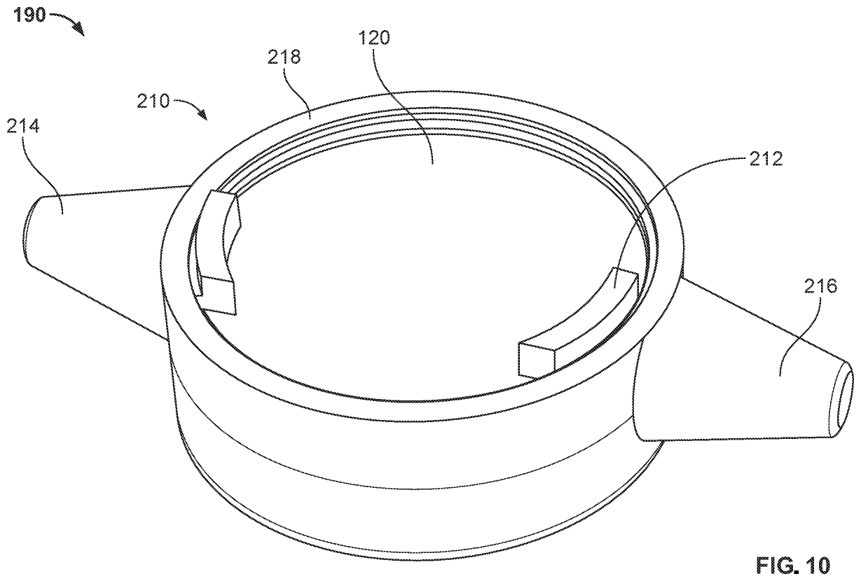

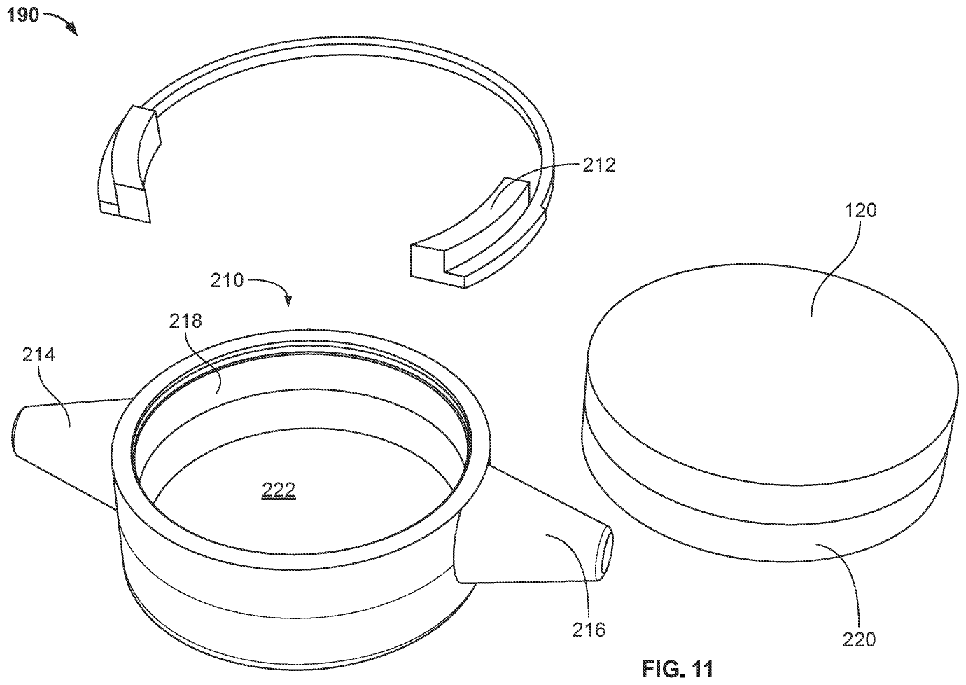

Looking to FIG. 11, in some embodiments, the sensor assembly 190 includes a battery 220 that powers the sensor 114. Additionally, the cup portion 218 defines a second cavity 222 that receives the battery 220 and the sensor 114. Further, the cup portion 218 is grooved to receive the snap ring 212.

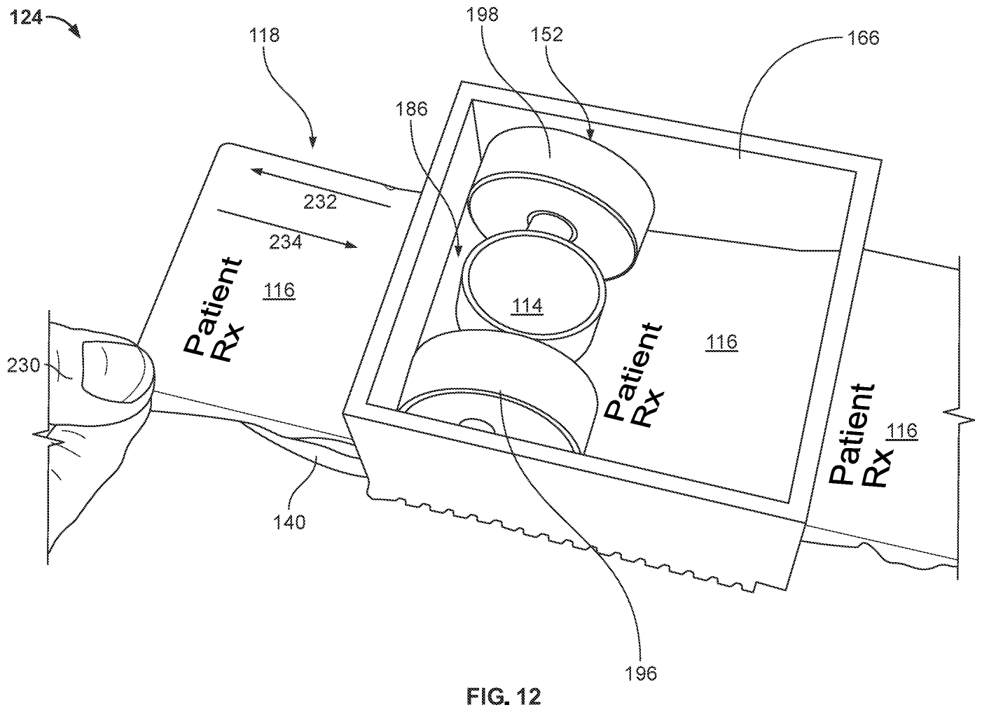

Turning to FIG. 12, in some embodiments, the first wheel 196 and/or the second wheel 198 are formed of and/or coated with an elastomeric material (e.g., rubber, foam, silicone, etc.). In operation, as a user 230 pulls the adherence medication strand 118 in a first direction 232 along the tray 140 out of the tracking assembly 124 via the dispensing opening 186, the adherence medication strand 118 engages the first wheel 196 and the second wheel 198 to pull the carriage assembly 152 in the first direction 232. Further, as the carriage assembly 152 is pulled in the first direction 232, the carriage assembly 152 rotates relative to the frame 166 and is periodically lifted upwardly by medication contained in the medication pouches 116.

Referring still to FIG. 12, in operation, when the adherence medication strand 118 moves in a second direction 234 opposite the first direction 232, the carriage assembly 152 shifts in the second direction 234 to engage the first guide wall at the first aft end (not shown) and the second guide wall 200 at the second aft end 206 (shown in FIG. 9). When the carriage assembly 152 is seated in the first aft end and the second aft end 206, the first guide wall and the second guide wall 200 work to impede rotation of the carriage assembly 152. Thus, the adherence medication strand 118, which is in contact with the first wheel 196 and the second wheel 198 is impeded from moving in the second direction 234.

Looking again to FIG. 12, the sensor 114 includes one or more devices configured to detect motion (e.g., accelerometer, gyroscope, etc.). In operation, as the adherence medication strand 118 is pulled in the first direction 232 and the second direction 234, the sensor 114 detects translational and rotational movement of the carriage assembly 152. The sensor 114 sends motion data to one or more of the computing devices 104 (shown in FIG. 1), which analyze the motion data.

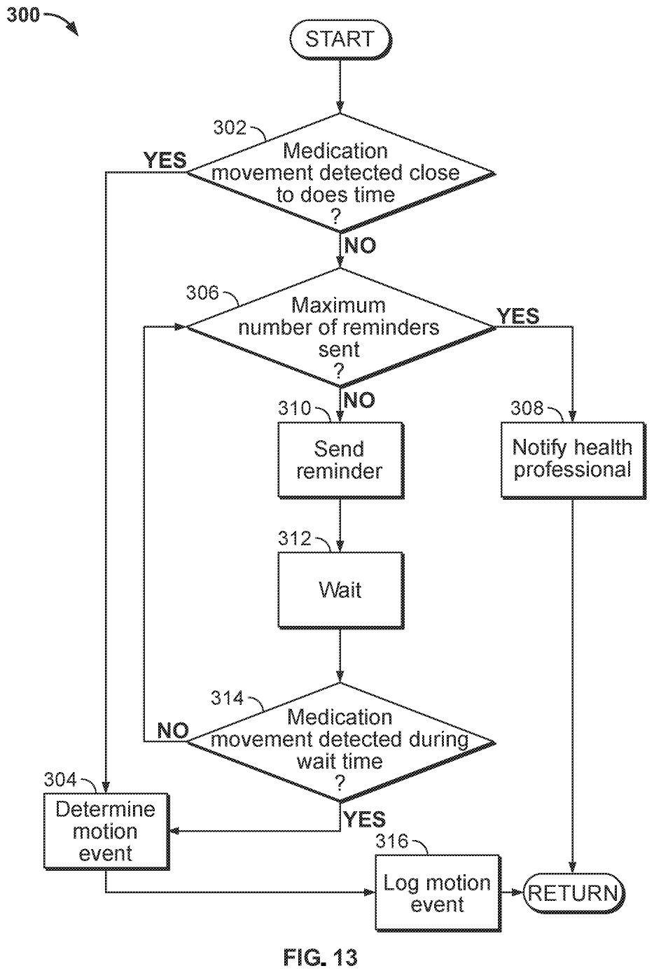

Turning to FIG. 13, a flow chart showing a method 300 for operating at least one device within the medication dispensing system 100 of FIG. 1 is shown. The method 300 starts at block 302, where one or more of the computing devices 104 determines whether movement of the adherence medication strand 118 is detected close to a predetermined dose time (e.g., within five minutes before or after the predetermined dose time).

If, at block 302, one or more of the computing devices 104 determine that movement of the adherence medication strand 118 was detected close to the predetermined dose time, the method 300 proceeds to block 304.

If, at block 302, one or more of the computing devices 104 determine that movement of the adherence medication strand 118 was not detected close to the predetermined dose time, the method 300 proceeds to block 306.

At block 306, one or more of the computing devices 104 determine whether a predetermined maximum number of reminders has been sent to the mobile device 110.

If, at block 306, one or more of the computing devices 104 determine that the predetermined maximum number of reminders has already been sent to the mobile device 110, the method 300 proceeds to block 308.

If, at block 306, one or more of the computing devices 104 determine that the predetermined maximum number of reminders has not yet been sent to the mobile device 110, the method 300 proceeds to block 310.

At block 308, one or more of the computing devices 104 contact a health professional that the adherence medication strand 118 has not moved.

At block 310, one or more of the computing devices 104 send a reminder to the mobile device 110 informing the patient to take the scheduled medication dose. The method 300 proceeds to block 312.

At block 312, the computing devices 104 wait a predetermined waiting period (e.g., five minutes) for the patient to take the scheduled medication dose. The method 300 proceeds to block 314.

At block 314, one or more of the computing devices 104 determine whether movement of the adherence medication strand 118 is detected during the predetermined wait time.

If, at block 314, one or more of the computing devices 104 determine that movement of the adherence medication strand 118 was detected during the predetermined wait time, the method 300 proceeds to block 304.

If, at block 314, one or more of the computing devices 104 determine that movement of the adherence medication strand 118 was not detected during the predetermined wait time, the method 300 retraces to block 306.

Going back to block 304, one or more of the computing devices 104 determine the motion event of the adherence medication strand 118 based on motion data from the sensor 114 and the algorithms 120. The method 300 proceeds to block 316.

At block 316, one or more of the computing devices 104 logs the motion event (e.g., time, dosage taken, event type, etc.). The method 300 then returns to block 302.

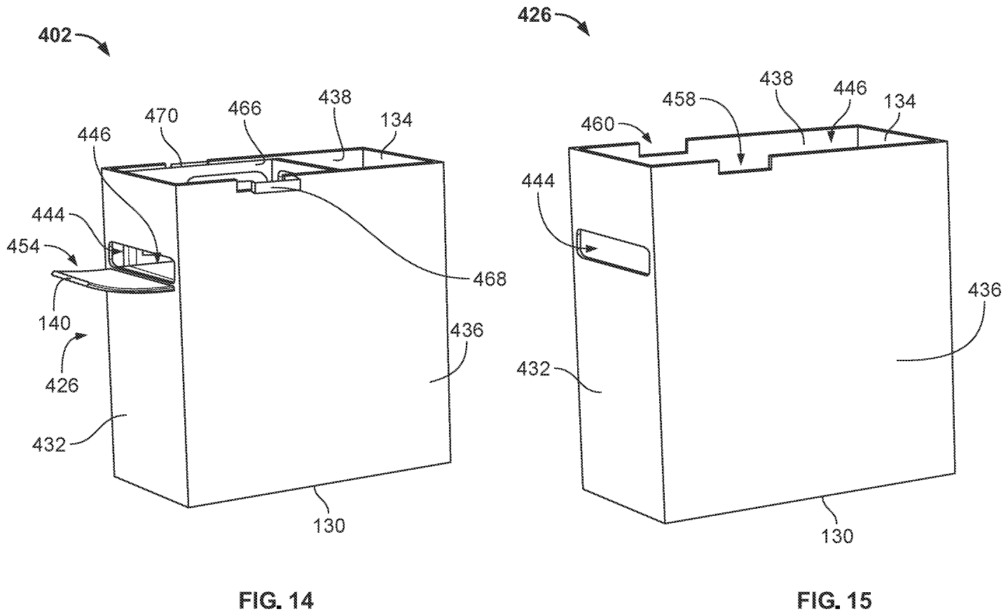

Referring now to FIG. 14, a second adherence package 402 includes a housing 426 supporting a dispensing sled 454. The housing 426 includes the bottom panel 130, a front panel 432, the back panel 134, a first side panel 436, and a second side panel 438. The dispensing sled 454 includes a frame 466 that supports the tray 140, a first retaining lobe 468, and a second retaining lobe 470. The first retaining lobe 468 and the second retaining lobe 470 engage the first side panel 436 and the second side panel 438, respectively.

Turning to FIG. 15, the front panel 432 defines a dispensing slot 444. The housing 426 defines a cavity 446. Additionally, the first side panel 436 and the second side panel 438 define a first notch 458 and a second notch 460, respectively.

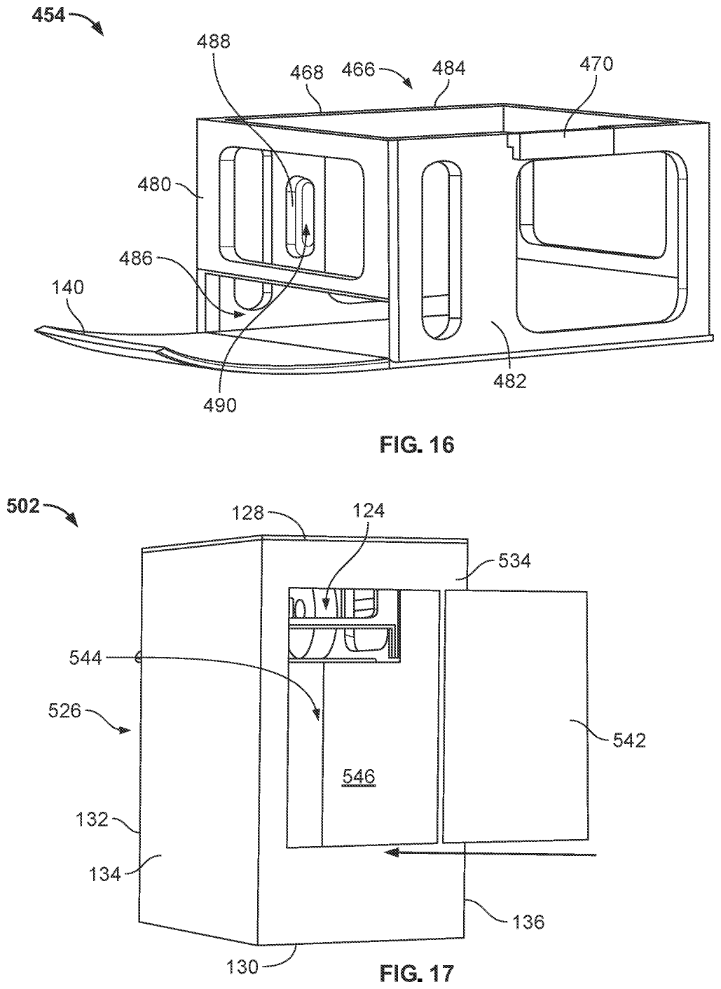

Looking to FIG. 16, the frame 466 supports the tray 140 and includes a front section 480 connected to and between a first side section 482 and a second side section 484. The tray 140 and the front section 480 define a dispensing opening 486. The first side section 482 supports the first retaining lobe 468 and a first guide wall (not shown). The second side section 484 supports the second retaining lobe 470 and a second guide wall 488. The first retaining lobe 468 and the second retaining lobe 470 are shaped to fit into the first notch 458 and the second notch 460 (shown in FIG. 15), respectively. The first guide wall and the second guide wall 488 extend inwardly toward one another. Further, the first guide wall and the second guide wall 488 define a first guide groove (not shown) and a second guide groove 490, respectively. Additionally, the tray 140 extends beyond the front section 480 and curves upwardly.

Referring to FIG. 17, a third adherence package 502 includes the tracking assembly 124 and a housing 526. The housing 526 includes the top panel 128, the bottom panel 130, the front panel 132, a back panel 534, the first side panel 136, the second side panel 138 and a door 542. The back panel 534 defines an opening 544. Further, the housing 526 defines a cavity 546, which is in communication with the opening 544. The door 542 is pivotably connected to the back panel 534 to selectively close the opening 544. The tracking assembly 124 sends motion data to the computing devices 104 (shown in FIG. 1) when the strand 118 of medication pouches 116 (shown in FIG. 12) held in the cavity 546 moves through the tracking assembly 124.

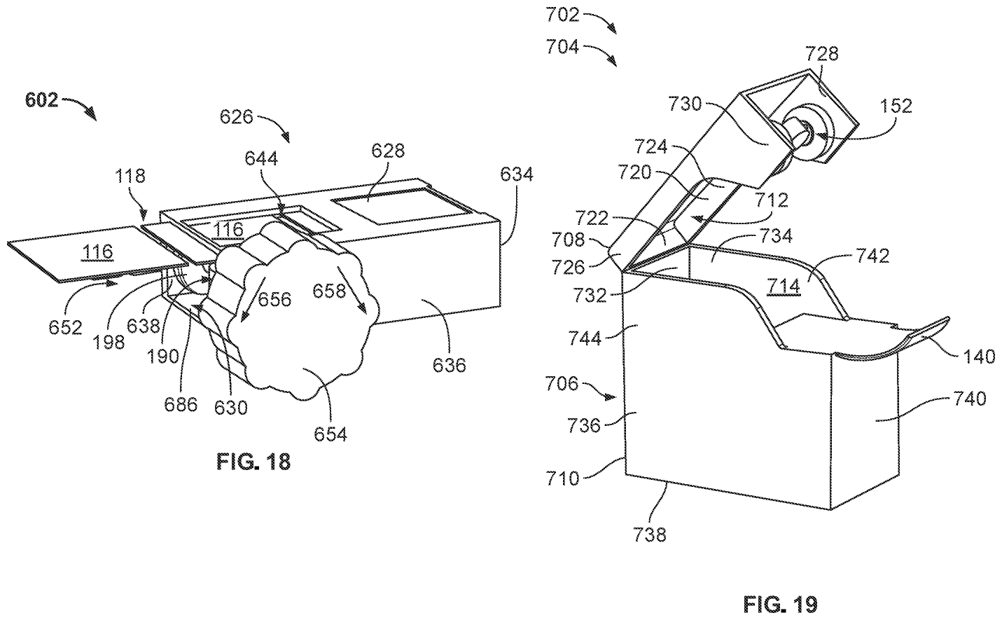

Referring to FIG. 18, a fourth adherence package 602 includes a housing 626 supporting a carriage assembly 652. The housing 626 includes a top panel 628, a bottom panel 630, a back panel 634, a first side panel 636, and a second side panel 638. The top panel 628 defines a window 644 through which medication pouches 116 of the strand 118 contained in the housing 626 may be viewed. The carriage assembly 652 includes the sensor assembly 190, a first axle (not shown), the second wheel 198, and a knob 654. The carriage assembly 652 also includes the second axle 194 and the first wheel 196 (shown in FIG. 8). The first axle supports the first wheel 196 and is connected to the knob 654 and the sensor assembly 190. When the knob 654 is turned in a first direction 656, the first wheel 196 and the second wheel 198 roll against the strand to advance medication pouches 116 out of a dispensing opening 686 defined by the housing 626. Similarly, When the knob 654 is turned in a second direction 658 opposite the first direction 656, the first wheel 196 and the second wheel 198 roll against the strand 118 to retreat medication pouches 116 into the housing 626. The sensor assembly 190 detects these movements and sends motion data to the computing devices 104 (shown in FIG. 1).

FIG. 19 illustrates a fifth adherence package 702 in an open configuration 704. The fifth adherence package 702 includes the tray 140 and the carriage assembly 152 supported by a housing 706. The housing 706 includes an upper portion 708 pivotably connected to a lower portion 710. More specifically, the upper portion 708 supports the carriage assembly 152 and the tray 140 extends from the lower portion 710. The upper portion 708 and the lower portion 710 define an upper cavity 712 and a lower cavity 714, respectively, to hold a strand 118 of medication pouches 116 (shown in FIG. 12).

Looking again to FIG. 19, the upper portion 708 includes a top panel 720, an upper back panel 722, a first upper side panel 724, and a second upper side panel 726. The first upper side panel 724 and the second upper side panel 726 include a first descending section 728 and a second descending section 730. The lower portion 710 includes a lower back panel 732, a first lower side panel 734, a second lower side panel 736, a bottom panel 738, and a front panel 740. The first lower side panel 734 and the second lower side panel 736 include a first ascending section 742 and a second ascending section 744, respectively.

Referring again to FIG. 19, the tray 140 is connected to the first lower side panel 734, the second lower side panel 736, and the front panel 740. Additionally, the tray 140 extends outwardly from the lower portion 710 beyond the front panel 740. Further, the upper back panel 722 is pivotably connected to the lower back panel 732. In a closed configuration (not shown), the first descending section 728 and the second descending section 730 matingly connect to the first ascending section 742 and the second ascending section 744, respectively. Also, in the closed configuration, the first descending section 728 and the second descending section 730 contact the tray 140.

Remaining with FIG. 19, as the strand 118 of medication pouches 116 (shown in FIG. 12) slides along the tray 140, the carriage assembly 152 rolls against the strand 118. The carriage assembly 152 detects these movements and sends motion data to the computing devices 104 (shown in FIG. 1).

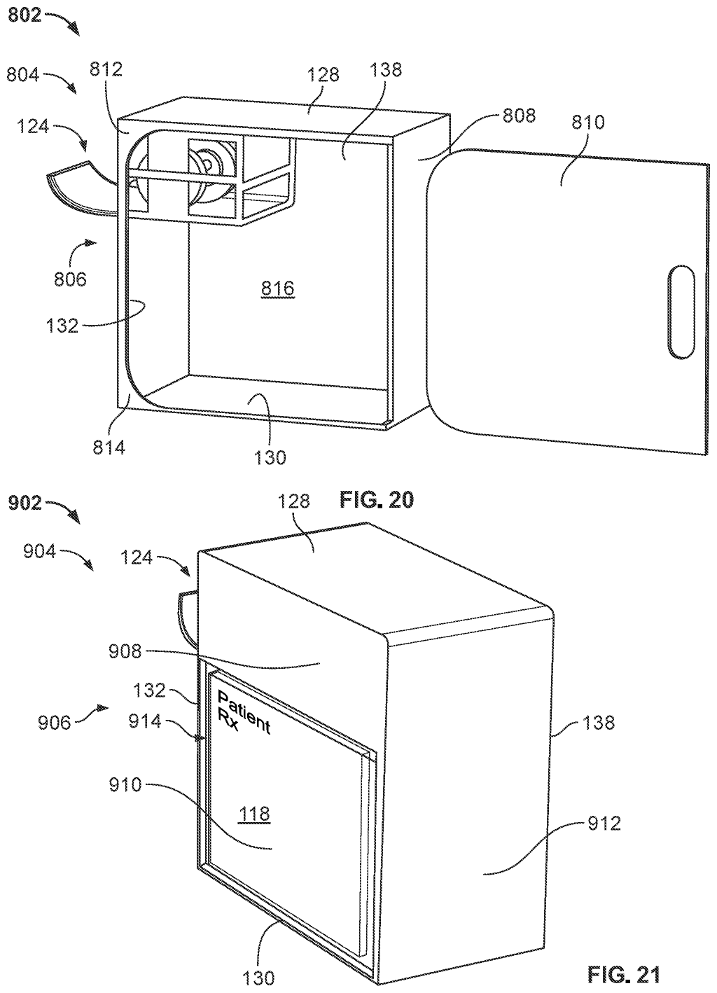

FIG. 20 illustrates a sixth adherence package 802 in an open configuration 804. The sixth adherence package 802 includes the tracking assembly 124 supported by a housing 806. The housing 806 includes a back panel 808, a first side panel 810, an upper stiffening rib 812, a lower stiffening rib 814, the top panel 128, the bottom panel 130, the front panel 132, and the second side panel 138. Further, the housing 806 defines a cavity 816.

Looking again to FIG. 20, the tracking assembly 124 is connected to the top panel 128, the second side panel 138, and the front panel 132. The upper stiffening rib 812 is connected to the top panel 128, the tracking assembly 124, and the front panel 132. The lower stiffening rib 814 is connected to the bottom panel 130 and the front panel 132. The first side panel 810 selectively slidably engages and is retained by the top panel 128 and the bottom panel 130. Thus, the first side panel 810 is removable from the top panel 128 and the bottom panel 130. In a closed configuration (not shown), the first side panel 810 selectively matingly abuts the upper stiffening rib 812 and the lower stiffening rib 814. The tracking assembly 124 sends motion data to the computing devices 104 (shown in FIG. 1) when the strand 118 of medication pouches 116 (shown in FIG. 12) held in the cavity 816 moves through the tracking assembly 124.

FIG. 21 illustrates a seventh adherence package 902 in a closed configuration 904. The seventh adherence package 902 includes the tracking assembly 124 supported by a housing 906. The housing 906 includes an upper first side panel 908, a lower first side panel 910, a back panel 912, the top panel 128, the bottom panel 130, the front panel 132, and the second side panel 138. Further, the housing 906 defines a cavity 914.

Referring again to FIG. 21, the tracking assembly 124 is connected to the top panel 128, the second side panel 138, the front panel 132, and the upper first side panel 908. The lower first side panel 910 snapably removably engages and is retained by the upper first side panel 908, the bottom panel 130, the front panel 132, and the back panel 912. In some embodiments, the lower first side panel 910 is transparent. Thus, the strand 118 of medication pouches 116 (shown in FIG. 12) stored in the cavity 914 may be viewed. The tracking assembly 124 sends motion data to the computing devices 104 (shown in FIG. 1) when the strand 118 of medication pouches 116 moves through the tracking assembly 124.

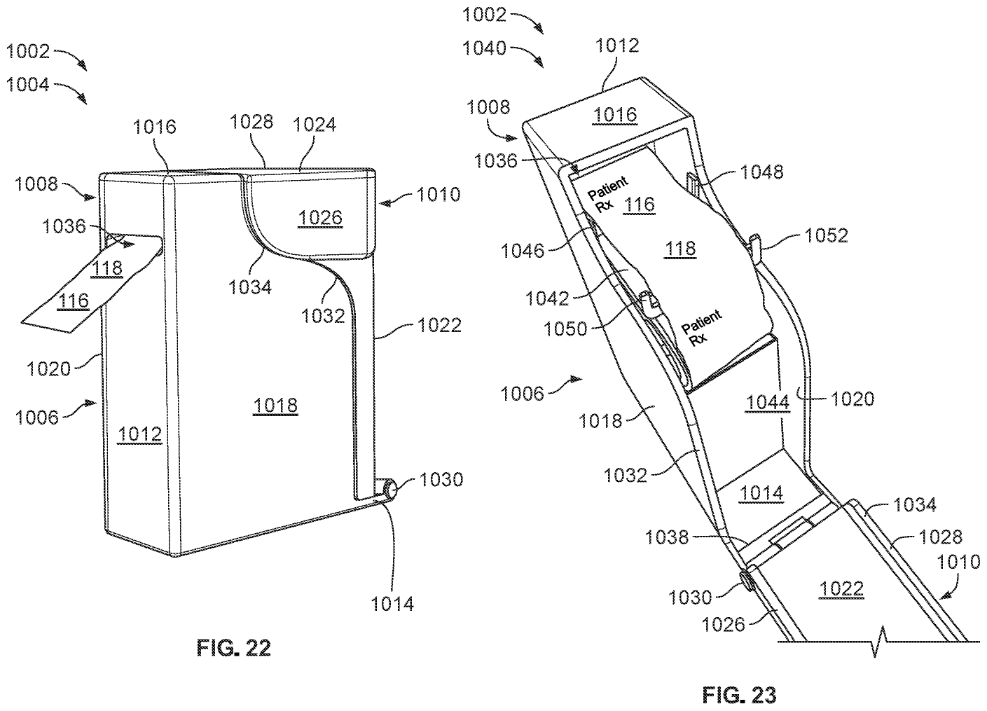

FIG. 22 illustrates an eighth adherence package 1002 in a closed configuration 1004. The eighth adherence package 1002 includes a housing 1006 configured to store the strand 118 of medication pouches 116. The housing 1006 includes a base portion 1008 pivotably engaged with a lid portion 1010. The base portion 1008 includes a front panel 1012, a bottom panel 1014, forward top panel 1016, a first forward side panel 1018, and a second forward side panel 1020. The lid portion 1010 includes a back panel 1022, a rear top panel 1024, a first rear side panel 1026, and a second rear side panel 1028. The back panel 1022 is pivotably engaged to the bottom panel 1014 via a hinge 1030. The hinge 1030 extends rearwardly beyond the back panel 1022.

Looking again to FIG. 22, the base portion 1008 has a curvilinear rear edge 1032 that matingly engages a curvilinear forward edge 1034 of the lid portion 1010. In some embodiments, the base portion 1008 snapably engages the lid portion 1010 in the closed configuration 1004. Additionally, the front panel 1012 defines a dispensing opening 1036.

FIG. 23 illustrates the eighth adherence package 1002 in an open configuration 1040. The eighth adherence package 1002 further includes a tray 1042 supported by the housing 1006. More specifically, the tray 1042 is connected to the front panel 1012, the first forward side panel 1018, and the second forward side panel 1020. Further, the tray 1042 extends into a cavity 1044 defined by the housing 1006.

Referring again to FIG. 23, a first forward guide post 1046, a second forward guide post 1048, a first rear guide post 1050, a second rear guide post 1052 extend upwardly from the tray 1042. The first forward guide post 1046 and the second forward guide post 1048 are also connected to the first forward side panel 1018 and the second forward side panel 1020, respectively. The first forward guide post 1046, the second forward guide post 1048, the first rear guide post 1050, and the second rear guide post 1052 work to retain and align the strand 118 of medication pouches 116 along the tray 1042 as the strand 118 is pulled out of the cavity 1044 through the dispensing opening 1036.

Remaining with FIG. 23, the bottom panel 1014 and the hinge 1030 form a lip 1038. When the lid portion 1010 and the base portion 1008 are in the closed configuration 1004 (shown in FIG. 22), the back panel 1022 seats against the lip 1038.

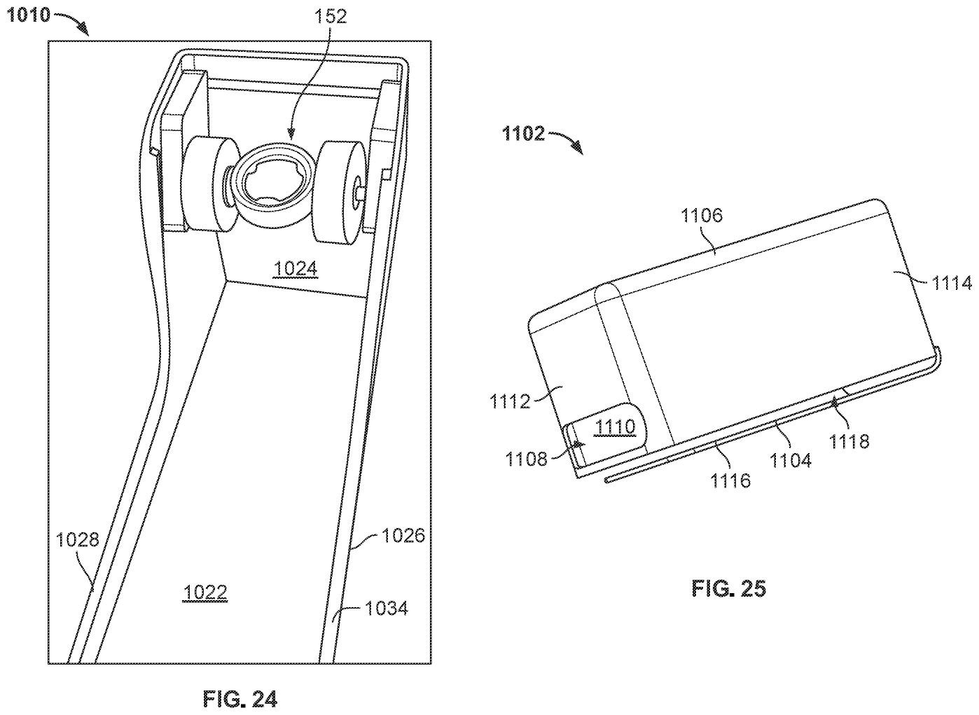

Turning to FIG. 24, the lid portion 1010 supports the carriage assembly 152. When the lid portion 1010 is closed relative to the base portion 1008. When the lid portion 1010 and the base portion 1008 are in the closed configuration 1004 (shown in FIG. 22), the carriage assembly 152 is positioned above the tray 1042 (shown in FIG. 23). As the strand 118 of medication pouches 116 (shown in FIG. 23) slides along the tray 1042, the carriage assembly 152 rolls against the strand 118. The carriage assembly 152 detects these movements and sends motion data to the computing devices 104 (shown in FIG. 1).

Turning to FIG. 25, a dispensing clip 1102 includes a hook 1104 extending from a housing 1106. The housing 1106 defines a dispensing opening 1108 in communication with a cavity 1110. Additionally, the housing 1106 has a forward end 1112 and a rear end 1114. The hook 1104 extends from the rear end 1114 toward the forward end 1112. The hook 1104 includes a flat blade portion 1116, which is distanced from the housing 1106. Further, the hook 1104 and the housing 1106 define a slot 1118. The housing 1106 defines a bottom opening (not shown) in communication with the slot 1118 and the cavity. The blade portion 1116 defines a passage (not shown) in communication with the slot 1118 and aligned with the bottom opening of the housing 1106. In some embodiments, the carriage assembly 152 (shown in FIG. 12) is supported by the housing 1106 in the cavity 1110.

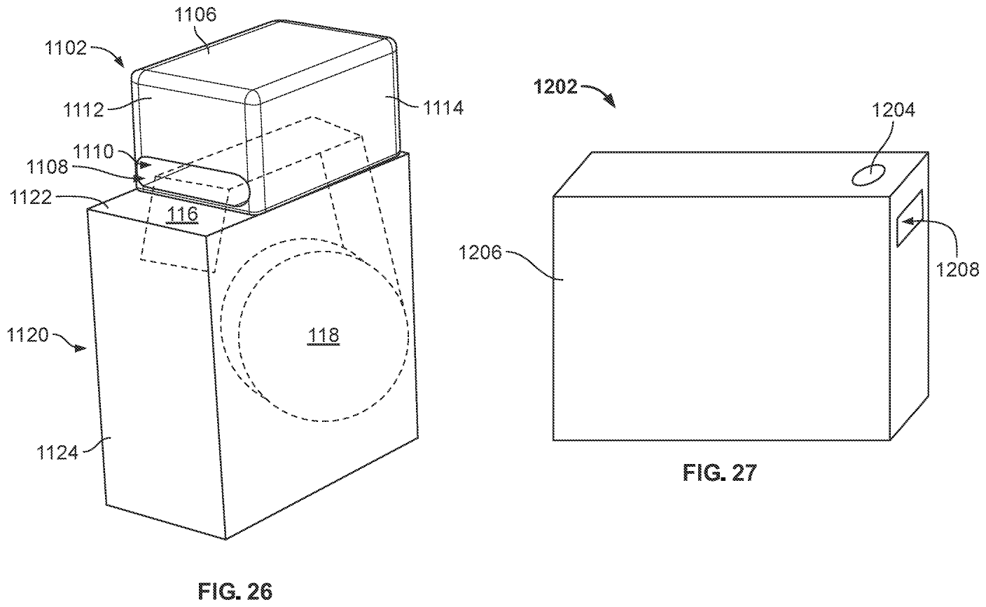

Referring to FIG. 26, in operation, the dispensing clip 1102 hooks onto a box 1120. More specifically, the blade portion 1116 (shown in FIG. 25) is inserted between a top panel 1122 and a lower portion 1124 of the box 1120. When the dispensing clip 1102 is mounted to the box 1120, the bottom opening of the housing 1106 and the passage of the blade portion 1116 (shown in FIG. 25) align with a hole (not shown) defined in the top panel 1122. Thus, in operation, a strand 118 of medication pouches 116 (shown in phantom) contained in the box 1120 may be pulled through passage in the blade portion 1116, the hole in the top panel 1122, the bottom opening of the housing 1106, and the cavity 1110 to exit through the dispensing opening 1108. As the strand 118 of medication pouches 116 slides through the housing 1106, the carriage assembly 152 (shown in FIG. 12) rolls against the strand 118. The carriage assembly 152 detects these movements and sends motion data to the computing devices 104 (shown in FIG. 1).

Looking now to FIG. 27, a ninth adherence package 1202 includes a button 1204 extending through a housing 1206, which defines a dispensing opening 1208. The ninth adherence package 1202 also includes a guide tray (not shown) supported in the housing 1206.

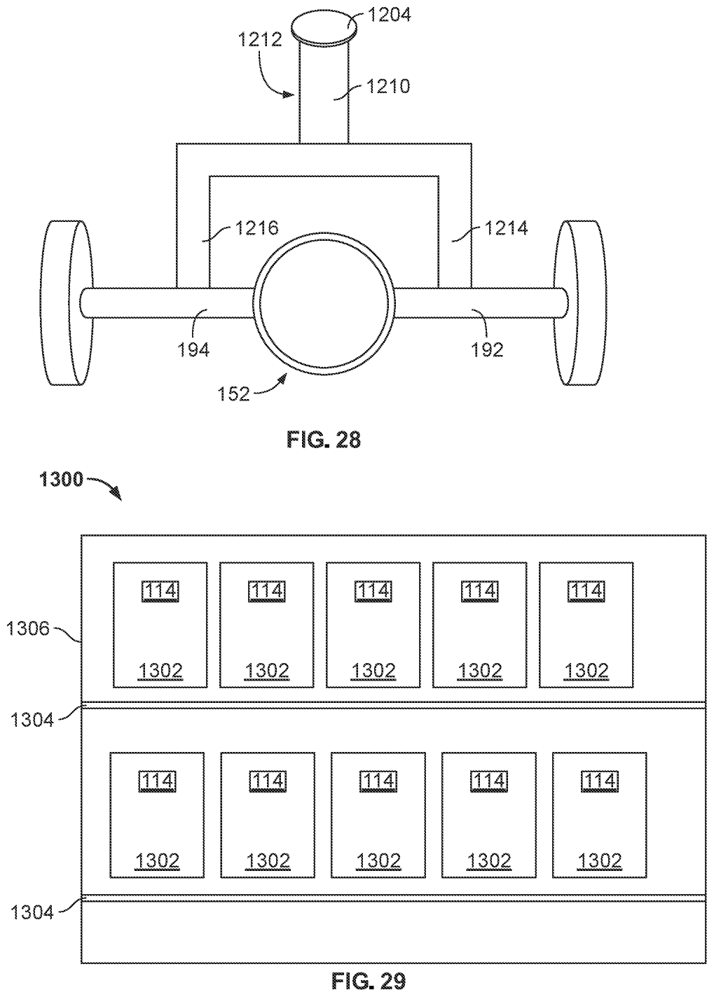

Referring to FIG. 28, the button 1204 is connected to a central stem 1210 of a presser fork 1212. The central stem 1210 is connected to a first tine 1214 and a second tine 1216. The presser fork 1212 engages the carriage assembly 152, which is mounted in the housing 1206 (shown in FIG. 27) above the guide tray. More specifically, the first tine 1214 and the second tine 1216 contact the first axle 192 and the second axle 194, respectively. As the strand 118 of medication pouches 116 (shown in FIG. 12) slides along the guide tray through the housing 1206, the carriage assembly 152 rolls against the strand 118. The carriage assembly 152 detects these movements and sends motion data to the computing devices 104 (shown in FIG. 1). Further, the button 1204 may be selectively depressed to push the carriage assembly 152 downwardly. Thus, the strand 118 is selectively pinched and retained between the carriage assembly 152 and the guide tray to aid a user in removing a medication pouch 116 from the strand 118. In some embodiments, the carriage assembly 152 is mounted in the housing 1206 via the central stem 1210, which is rotatable relative to the housing 1206. Thus, in some embodiments, the presser for 1212 and the carriage assembly 152 work together as a gimbal.

Turning to FIG. 29, an adherence package station 1300 includes a plurality of adherence packages 1302 supported on shelves 1304 of a cabinet 1306. Each of the adherence packages 1302 include a sensor 114 that sends data to the computing devices 104 (shown in FIG. 1) to track dispensing of medication pouches 116.

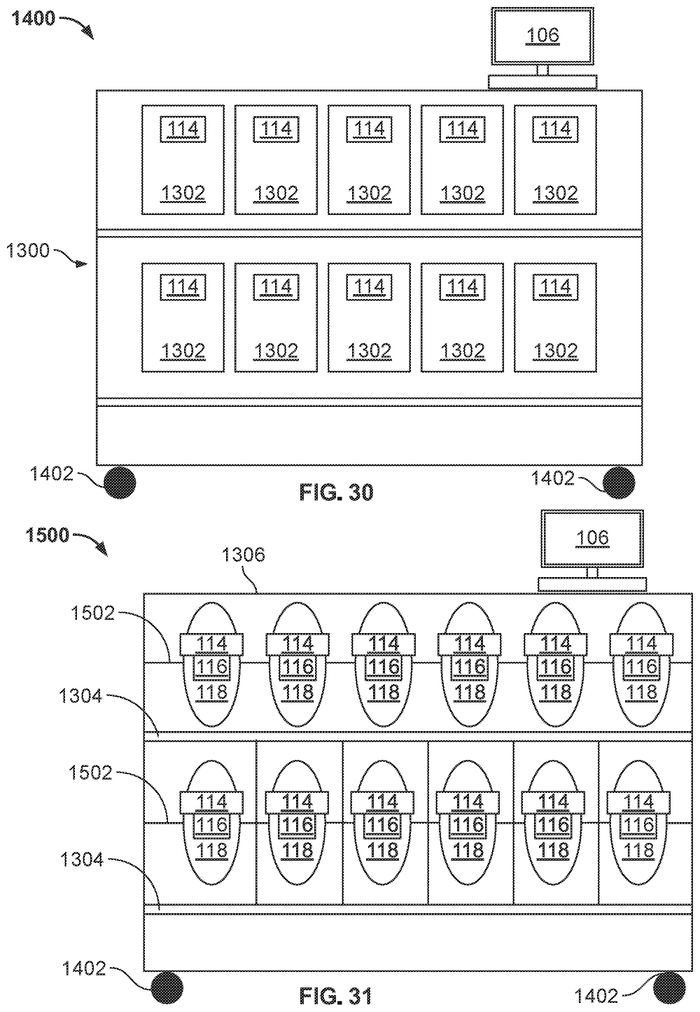

Looking now to FIG. 30, a first adherence package cart 1400 includes the computer terminal 106 mounted the adherence package station 1300, which is supported by a plurality of wheels 1402. The computer terminal 106 logs and analyzes the medication dispensing data sent by the sensors 114.

Referring to FIG. 31, a second adherence package cart 1500 includes a plurality of rods 1502 supported in the cabinet 1306, which is supported by the plurality of wheels 1402. Strands 118 of medication pouches 116 are wrapped about the rods 1502. When dispensing medication, each strand 118 is pulled past one of the sensors 114, which sends medication dispensing data to the computer terminal 106. The computer terminal 106 logs and analyzes the medication dispensing data from the sensors 114.

In other embodiments, other configurations are possible. For example, those of skill in the art will recognize, according to the principles and concepts disclosed herein, that various combinations, sub-combinations, and substitutions of the components discussed above can provide appropriate cooling for a variety of different configurations of motors, pumps, electronic assemblies, and so on, under a variety of operating conditions.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. An adherence package comprising:
a housing; and
a sensor supported in the housing, the sensor being configured to detect movement of a strand of medication pouches stored in the housing.

2. The adherence package of claim 1, wherein the sensor is rotatably supported in the housing.

3. The adherence package of claim 1, wherein the sensor is mounted in a carriage assembly.

4. The adherence package of claim 3, wherein the carriage assembly is rotatably and slidably mounted in the housing.

5. The adherence package of claim 4, wherein the housing includes a guide wall defining a guide groove, the carriage assembly rides in the guide groove, and the guide wall limits sliding movement of the carriage assembly.

6. The adherence package of claim 1, wherein the sensor is mounted in a frame.

7. The adherence package of claim 6, wherein the frame is slidably mounted in the housing.

8. The adherence package of claim 7, wherein the housing defines a groove, a guide rail extends from the frame, and the guide rail is slidably received by the groove.

9. The adherence package of claim 7, wherein the housing has a lip and a stop and the frame engages the lip and the stop.

10. A medication dispensing system comprising:
a computing device; and
an adherence package in communication with the computing device via a cloud network, the adherence package including
a housing, and
a sensor supported in the housing, the sensor being configured to detect movement of a strand of medication pouches stored in the housing.

11. The medication dispensing system of claim 10, wherein the sensor sends motion data of the strand to the computing device.

12. The medication dispensing system of claim 11, wherein the computing device determines a motion event based on the motion data.

13. The medication dispensing system of claim 11, wherein the computing device determines whether a medication dose from the strand has been dispensed in accordance with a predetermined medication schedule based on the motion data.

14. The medication dispensing system of claim 11, wherein the computing device is in communication with a mobile device via the cloud network and the computing device sends medication reminders to the mobile device.

15. The medication dispensing system of claim 10, wherein the sensor is mounted in a carriage assembly and the carriage assembly is rotatably and slidably mounted in the housing.

16. The medication dispensing system of claim 15, wherein the carriage assembly includes a wheel and the carriage assembly rotates when the strand is pulled against the wheel.

17. The medication dispensing system of claim 15, wherein the housing includes a guide wall defining a guide groove, the carriage assembly rides in the guide groove, and the guide wall limits sliding movement of the carriage assembly.

18. A method for dispensing medication comprising:
determining, with a computing device, whether a strand of medication pouches has moved in an adherence package close to a dose time;
if the strand of medication pouches has not moved in the adherence package close to the dose time, determining, with the computing device, whether a maximum number of reminders has been sent to a mobile device in communication with the computing device; and
if the maximum number of reminders has not yet been sent to the mobile device, sending, with the computing device, a reminder to the mobile device.

19. The method of claim 18, further comprising determining, with the computing device, whether the strand of medication pouches has moved in the adherence package during a waiting period after the reminder is sent.

20. The method of claim 18, wherein the computing device is a first computing device and further comprising, if the maximum number of reminders has already been sent to the mobile device, contacting, with the first computing device, a second computing device of a health professional.
